(19) United States
(12) Patent Application Publication
(10) Pub. No.: US 2012/0013611 A1
(43) Pub. Date: Jan. 19, 2012

(54) System and Method for Visualizing Multi-Dimensional Data Using Shape Attributes

(76) Inventor: Richard Brath, Toronto (CA)

(21) Appl. No.: 13/180,707

(22) Filed: Jul. 12, 2011

(30) Foreign Application Priority Data
Jul. 14, 2010 (CA) 2,709,507

(51) Int. Cl. G06T 15/00

(52) U.S. Cl. 345/419

(57) ABSTRACT

There is provided a method and system for visualizing multi-dimensional data on a user interface of a computing device, each dimension of the data having a plurality of values defining the associated values of the data for the dimension. The method comprises receiving mapping information defining at least one mapping between each potential dimension of the data to a corresponding shape attribute. The method further comprises generating, for each dimension of the data, a plurality of visual markers in response to varying a pre-defined visual characteristic of the corresponding shape attribute from a baseline shape for the characteristic, the plurality of visual markers configured for representing the dimension values of the dimension and each of the visual markers varying a pre-defined measure from the baseline shape and defining, for each dimension of the data, a link between each visual marker associated with the corresponding shape attribute with each potential dimension value of the plurality of dimension values, the link defined in response to pre-defined criteria. The method further comprises representing each dimension value of each dimension of the multi-dimensional data with the linked visual marker and concatenating the plurality of visual markers corresponding to each of the different dimensions of the multi-dimensional data and associated dimension values to form a singular visual object for visualizing the multi-dimensional data and associated dimension values.

### CROSS REFERENCE TO RELATED APPLICATIONS

This application claims priority, under 35 U.S.C. 119, from Canadian Patent Application No. 2,709,507 filed Jul. 14, 2010.

### FIELD OF THE INVENTION

This application relates to a system and method for visualizing multi-dimensional data using shape attributes and particularly to displaying the many dimensions of the data within a singular visual marker.

### BACKGROUND OF THE INVENTION

Traditionally, shape has been poorly characterized within the information visualization community, although several researchers have identified shapes that may be useful for identifying data. Some references have previously identified a single attribute such as shape as a potentially useful visual variable for representing categorical data. These references have also been skeptical regarding the use of shape for representing data, and have displayed numerous examples of poor use of shape within a visual display. Traditionally, other visual representations for data have been used as a means for conveying data within a glyph. Typically, within a visual representation, such as a scatterplot, a dot or other shape is used to indicate a data point. To represent more than one data attribute the shape may become more complex and thus visually difficult to perceive or analyze.

Most of the techniques have been focused on generating smooth, curved shapes based to represent continuous quantitative data, such as tensor data. For example, superquadrics and similar variants of curvature-based parametric shapes in scientific visualization, have been used in numerous expressive visualizations.

In iconic techniques for feature visualization a variety of compound glyphs are utilized. In blobs, or more specifically, implicit surfaces based on volume rendering of density fields, provides another algorithmic means for generating smooth, closed, curved shapes based on data. In this case, different areas of the surface correspond to different data attributes. However, the existing feature visualization representations are generally complex structures and thus it is visually difficult to decipher the underlying data. Additionally, the disadvantage of at least some of these techniques is that the more complex shapes that define the data don't visually pop out and therefore are ineffective for users.

Accordingly, there exists a need for a system and method for visually depicting multiple dimensions of data at one time using shapes and their attributes for visualization in a manner as to optimize ease of readability and understanding.

### SUMMARY OF THE INVENTION

According to one aspect there is provided a computer-implemented method for visualizing multi-dimensional data on a user interface of a computing device, each dimension of the data having a plurality of dimension values, the method comprising: receiving mapping information defining at least one mapping between each potential dimension of the data to a corresponding shape attribute; generating, for each dimension of the data, a plurality of visual markers in response to varying a pre-defined visual characteristic of the corresponding shape attribute from a baseline shape for the characteristic, the plurality of visual markers configured for representing the dimension values of the dimension and each of the visual markers varying a pre-defined measure from the baseline shape; defining, for each dimension of the data, a link between each visual marker associated with the corresponding shape attribute with each potential dimension value of the plurality of dimension values, the link defined in response to pre-defined criteria; and representing each dimension value of each dimension of the multi-dimensional data with the linked visual marker and concatenating the plurality of visual markers corresponding to each of the different dimensions of the multi-dimensional data and associated dimension values to form a singular visual object for visualizing the multi-dimensional data and associated dimension values.

The method further comprises: receiving input on the user interface from a user of the device for allowing one or more of defining the mapping information; modifying the mapping information; selecting the visual characteristic; and selecting the pre-defined criteria for determining the link between each visual marker and a selected dimension value of the data. In one aspect, concatenating the visual markers from each of the dimensions of data and associated values comprises presenting each visual marker corresponding to a different data dimension in a different visual dimension. In another aspect, the visual object is displayed as one of a two-dimensional or a three-dimensional object. In yet another aspect, the shape attributes are selected from the group comprising: closure, curvature, corner angle, edge type, corner type, end type, notch, bump, whiskers, holes, intersection, and local warp. In yet another aspect, wherein the visual characteristics of the shape attributes are selected from the group comprising: degree of closure, amplitude, skew, bulge, degree of angle, amplitude, frequency, size, width, depth, density, length, number, number of spokes of an intersection, and factor. In yet another aspect, the visual characteristics of the shape attributes are selected from the group comprising: closed closure, open closure, degrees of curvature, straight edge, spiky edge, sharp corner, round corner, serif corner, serif end type, dot end type, v-shaped notch, half-round notch, sloping whiskers, amount of whiskers, shape of holes, number of holes, shear of warp, twist of warp, bulge of warp, and shape of notch. In yet another aspect, each visual marker of the visual markers connected together to form the visual object represents different dimensions of the multi-dimensional data and is visually displayed in different quadrants of the user interface.

In an alternative, aspect, the mapping information is configured to define that each dimension of the multi-dimensional data is mapped to different shape attributes of a plurality of shape attributes such that the singular visual object depicting the multi-dimensional data comprises visual markers associated with the plurality of shape attributes.

In yet another aspect, the corresponding shape attribute is selected in dependence upon a type of the potential dimension values for the dimension such that the corresponding shape attribute is associated for defining either categorical data having discrete potential dimension values or quantitative data having a range of potential dimension values.

In yet another aspect, the visual markers corresponding to different dimensions of the multi-dimensional data are generated from the same corresponding shape attribute having different visual characteristics.

In yet another aspect, the pre-defined criteria for linking each visual marker with each potential dimension value associated with the selected dimension is dependent upon the number of potential dimension values for the selected dimension.

In yet another aspect, the pre-defined criteria defines that the link between the linked visual marker and a selected dimension value of the data is in dependence upon a correlation between the pre-defined measure of variance and a relative size of the selected dimension value to the other values within a same dimension.

In another aspect, there is provided a computer-implemented system for visualizing multi-dimensional data on a visual interface of a computing device, each dimension of the data having a plurality of dimension value, the system comprising: a mapping tool for generating mapping information defining at least one mapping between each potential dimension of the data to a corresponding shape attribute, the mapping information generated in response to pre-defined criteria, the mapping tool further configured for generating, for each dimension of the data, a plurality of visual markers in response to varying a pre-defined visual characteristic of the corresponding shape attribute from a baseline shape for the characteristic, the plurality of visual markers configured for representing the dimension values of the dimension and each of the visual markers varying a pre-defined measure from the baseline shape, the mapping tool further configured for defining a mapping table for providing, for each dimension of the data, a link between each visual markers associated with the corresponding shape attribute with each potential dimension value of the plurality of dimension values, the link defined in response to pre-defined criteria; and a visualization tool for representing each dimension value of each dimension of the multi-dimensional data with the linked visual marker and concatenating the plurality of visual markers corresponding to each of the different dimensions of the multi-dimensional data and associated dimension values to form a singular visual object for visualizing the multi-dimensional data and associated dimension values in response to receiving the mapping table at the visualization tool.

### BRIEF DESCRIPTION OF THE DRAWINGS

A better understanding of these and other embodiments of the present invention can be obtained with reference to the following drawings and detailed description of the preferred embodiments, in which:

FIG. 1A is a block diagram of a data processing system for a visualization tool and FIG. 1B is a block diagram of further details;

FIG. 2 is an example database of shape attributes and their exemplary visual characteristics for use by the mapping tool of the data processing system;

FIGS. 3 and 4 illustrate an example for generating visual markers for two-dimensional data using a selected same shape attribute for both dimensions of the data;

FIG. 5 illustrates another example for generating visual markers for two-dimensional data;

FIG. 6 illustrates an example for generating visual objects using multiple shape attributes to represent the multi-dimensional data;

FIGS. 7-9 provide examples of potential shape attributes for use with the data processing system of FIG. 1A;

FIG. 10 provides an example of applying the system of FIG. 1A to a story having multi-dimensional data contained therein;

FIG. 11 illustrates an example of using curvature as a shape attribute for depicting multi-dimensional data by varying the visual characteristics of the shape attributes according to one embodiment;

FIG. 12 illustrates exemplary shape attributes and their corresponding sub-attributes; and

FIG. 13 illustrates an example for generating singular visual objects for each subset of multi-dimensional data using different shape attributes for each dimension of each multi-dimensional data.

### DETAILED DESCRIPTION

### Data Processing System 100

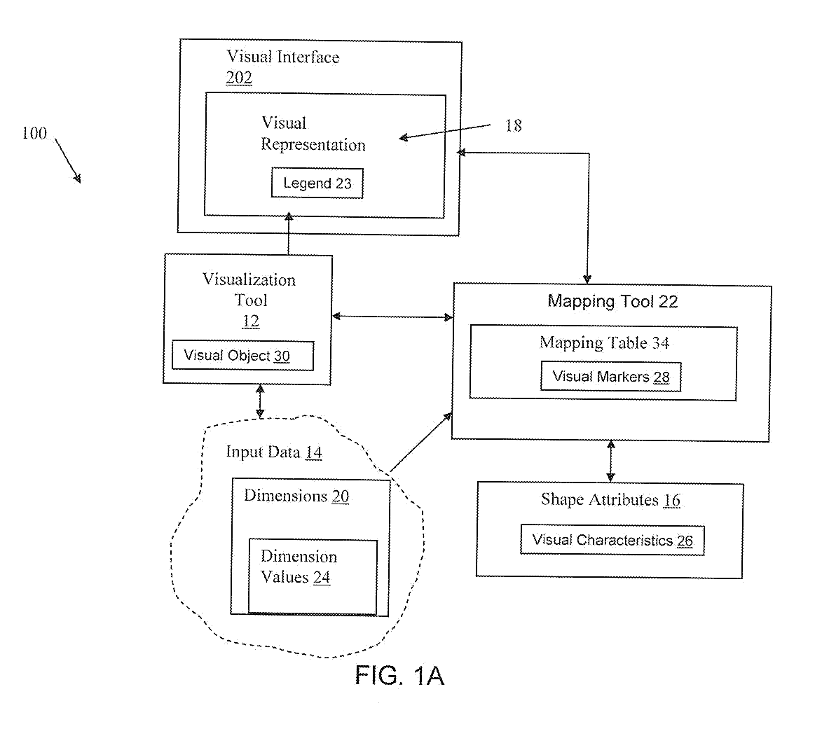

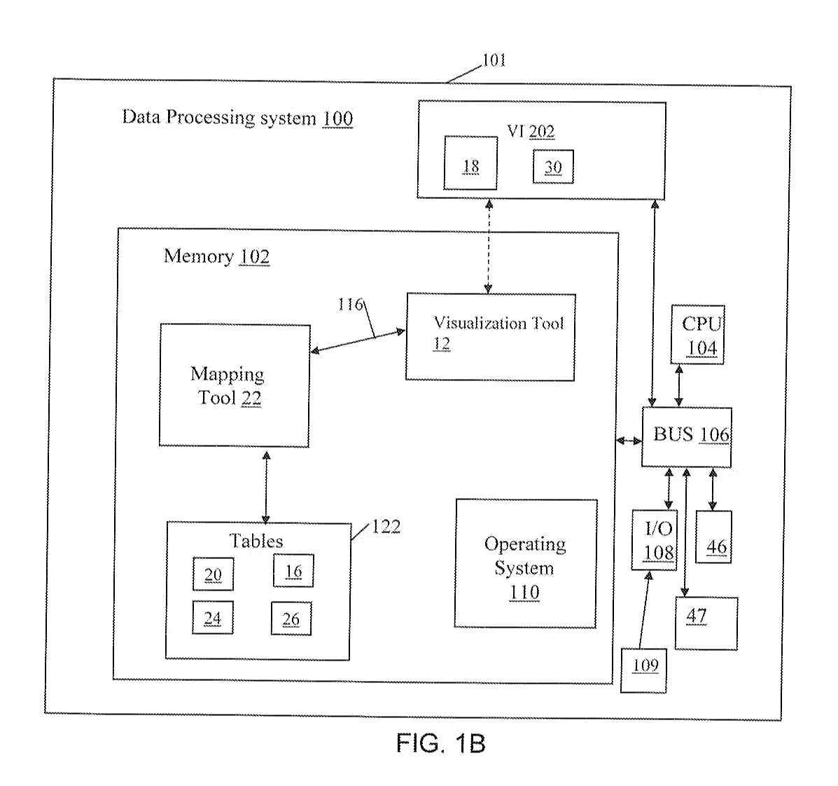

Referring to FIG. 1A, a visualization data processing system 100 includes a visualization tool 12 for receiving multi-dimensional data 14 having a plurality of dimensions 20 defining the data and dimension values 24 providing values for each dimension 20. For example, a selected dimension 20 of the data can refer to a variable, a property or other characteristic that defines the data 14 in such a way as to provide a different view of aspect or context of the data according to its selected dimension 20. Each dimension 20 of the data has corresponding dimension values 24 defining the values of the data according to its dimension 20. Accordingly, dimensions 20 are different measurable attributes of the data, such as payment type, fuel grade, gender, age, income, percent change, volume, etc. In one embodiment, the dimension 20 can have dimension values 24 that are categorical (e.g. fuel grades can be one of three conditions: regular, mid, premium) such that there are unique categories which the dimension values can be characterized as. In an alternate embodiment, the dimension 20 can have values that are quantitative such as age (defined by a number) which is an ordered value whether represented as a few integers or floating point number. Other types of dimension values 24 can be envisaged by a person skilled in the art. In one example, as will be described, the dimensions 20 of the data 14 for a gas survey may include the fuel grades and the payment types for the gas. The dimension values 24 of the data may include the values (or the potential values that may be used for generating the legend 23 and the mapping table 34) for the dimension 20. Referring to FIG. 1A, the legend 23 is a visual representation of the mapping table 34 and is displayed on the display 18. The mapping table 34 is a database or storage comprising the visual markers 28 for the multi-dimensional data 14. That is, the mapping table 34 comprises the mapping information between a visual marker 28 and a selected dimension data value 24 for a corresponding dimension 20. In this manner, the mapping table 34 contains mapping between all potential data dimension values 24 of each dimension 20 being mapped to corresponding visual markers 28. That is, for the fuel grades dimension 20, the dimension value 24 may include regular, mid-grade, and premium. While for the payment type dimension 20, the dimension value 24 may include cash, debit, credit card or branded card.

The visualization tool 12 further receives mapping information from a mapping tool 22 which is configured to provide a mapping table 34 comprising visual markers 28 configured for visualizing the data 14, the visual markers 28 generated in response to pre-defined shape attributes 16 and visual characteristics 26. That is, the mapping tool 22 provides mapping between each dimension 20 of the data 14 and a corresponding shape attribute 16.

As described earlier, each selected dimension 20 of the data 14 comprises one or more dimension values 24 that define the values of the data for that selected dimension. On the other hand, each shape attribute 16 comprises one or more visual characteristics 26 that may be used to further define the shape attribute 16. For example, in the case where the shape attribute 16 refers to curvature of a line or a curve shape, then the visual characteristics 26 may include one or more of: degree of curvature, amplitude, skew, bulginess, etc. Accordingly, the mapping tool 22 utilizes the characteristics 26 to create different perceptually distinguishable curve shapes. That is, the mapping tool 22 varies a pre-defined visual characteristic 26 (i.e. degree of curvature) of a shape attribute 16 (i.e. curvature) from a baseline shape or value (i.e. a flat line having zero degree of curvature) to obtain a plurality of shape variations or visual markers 28. In the example of a curve shape attribute 16, each visual marker 28 is a different curve shape with a pre-defined degree of curvature (the degree of curvature of a first visual marker 28 being different than that of a second other visual marker 28).

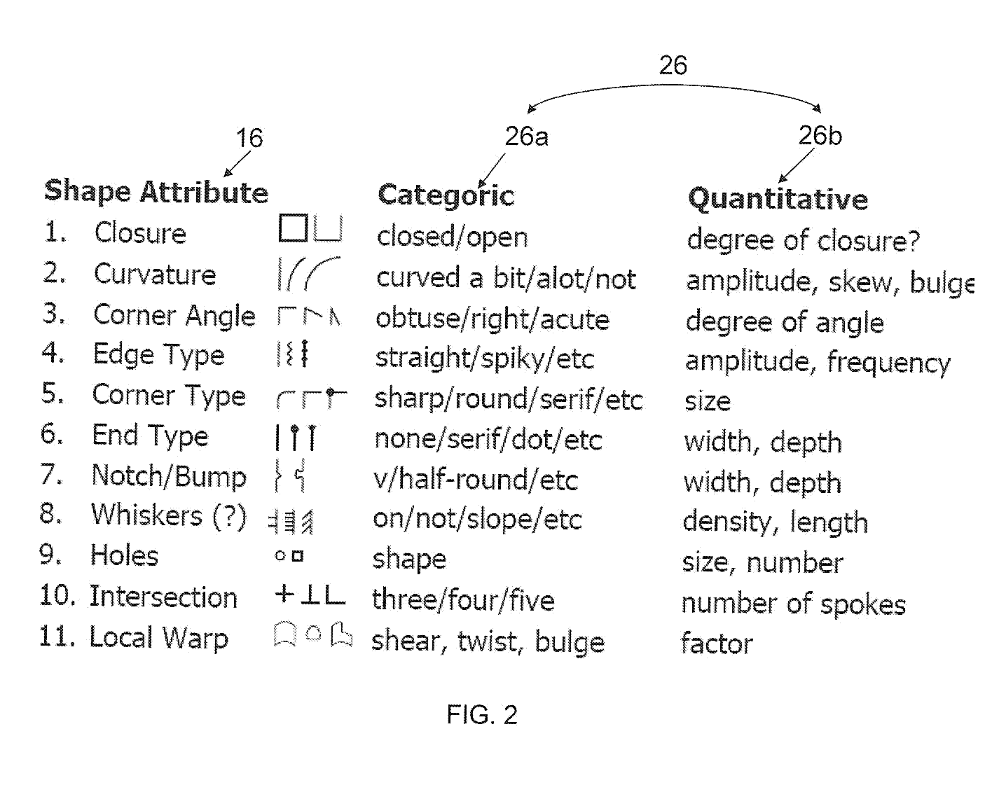

Referring to FIG. 1A, one or more shape attributes 16 and their associated visual characteristics 26 may be pre-defined and/or user-selected via the user input 202. The mapping tool 22 is further configured to retrieve the shape attributes 16 and the pre-defined visual characteristic 26 for generating the visual markers 28 for each dimension 20 of the data 14. That is, the mapping tool 22 receives pre-defined settings that are configured to define a mapping between a selected dimension 20 of a the data (i.e. fuel grade) and a selected shape attribute 16 (i.e. curvature) for representing the data dimension 20. The mapping between the selected dimension 20 and the shape attribute 16 may be automated (i.e. selected by the mapping tool 22 based on pre-defined mapping criteria); semi-automated (i.e. with user input or pre-defined settings that aid in selecting the selected shape attribute 16 to represent a data dimension 20); or user-defined via user input 202. In one embodiment, the pre-defined mapping criteria that is configured to define the mapping between a particular dimension 20 and a particular shape attribute 16 may include criteria that defines a list of candidate shape attributes 16 that may be better suited for representing the particular dimension 20 type. For example, as will be described in relation to FIG. 2, dimensions 20 having quantitative dimension values 24 may be better represented with selected types of shape attributes 16 and visual characteristics 26 (i.e. 26b). In another example, a data dimension 20 whose dimension values 24 defining the dimension 20 includes one of a number of predefined values may be better represented with a subset of shape attributes 16 having categorical visual characteristics 26a that can represent the desired number of potential values 24 of the dimension 20.

In another embodiment, the pre-defined mapping criteria provide a ranked order of shape attributes 16 and a ranked order of visual characteristics 26 for each shape attribute 16 for subsequent use by the mapping tool 22 in generating the visual markers 28 for representing each dimension 20 of the data.

In one aspect, the data processing system 100 is configured to receiving input on the user interface 202 from a user of the device for allowing one or more of defining the mapping information; modifying the mapping information; selecting the visual characteristic; and selecting the pre-defined criteria for determining the link between each visual marker 28 and a selected dimension value 24 of the data.

Accordingly, in one example according to the present embodiment a first dimension of data 20 may contain quantitative values 24. Accordingly, based in the pre-defined mapping criteria, the mapping tool 22 determines that the first dimension 20 is suited for representation by a subset of shape attributes 16 that have quantitative visual characteristics 26a (FIG. 2). Additionally, the mapping criteria accessed by the mapping tool 22 may define a ranked order of shape attributes 16 and a ranked order of visual characteristics 26 provided for each shape attribute 16. In this manner, the first dimension 20 may be mapped (by the mapping tool 22) to the highest ranked shape attribute 16 and each value 24 or the first dimension 20 may be represented by (and linked to) visual markers 28 that are generated in response to varying the highest ranked visual characteristic 26 by different measures from a baseline value to form each visual marker 28.

Referring again to FIG. 1A, based upon the mapping between a selected dimension 20 of the multi-dimensional data 14 and a selected shape attribute 16, the mapping tool 22 is configured to vary the visual characteristic 26 of the shape attribute 16 from a baseline shape or value or measure to obtain a plurality of shape variations defined as visual markers 28. Each visual marker 28 deviates from the baseline shape by a corresponding pre-defined measure or degree. The mapping tool 22 is configured to link each visual marker 28 (corresponding to the selected shape attribute 16) to each of the values 24 of the selected dimension 20 (mapped to the selected shape attribute 16) in response to pre-defined criteria. The linking between each visual marker 28 of a selected shape attribute 16 to each dimension value 24 of a selected dimension 20 (the selected dimension 20 being mapped to the selected shape attribute 16) is stored in the mapping table 34. In this manner each of the visual markers 28 associated with a selected shape attribute 16 is linked to a corresponding dimension value 24 of an associated dimension 20, the associated dimension 20 being mapped to the selected shape attribute 16. As will be described, in one embodiment, the pre-defined criteria may comprise instructions and/or selection constraints and/or a ranked list of visual characteristics 26 for selecting a particular visual characteristic 26 to be varied in order to generate the visual marker 28 for a particular value 24 of the associated dimension 20.

The visualization tool 12 is then configured to retrieve mapping table 34 information containing the visual mappings of each potential dimension value of the data 24 to each visual marker 28. The visualization tool 12 is further configured to generate a visual representation of the input data 14. It is noted that the data 14 may be pre-decomposed into the dimensions 20 and corresponding dimension values prior to being received at the visualization tool 12 or the data 14 may be received in its raw format and decomposed by the visualization tool 12 into its dimensions 20 for subsequent generation of one or more visual objects 30 to represent each subset of multi-dimensional data 14.

In one embodiment, the data processing system 100 operates as follows: for a given data dimension 20, the visualization tool 12 and/or mapping tool 22 determine whether the dimension 20 is categorical or numerical (quantitative). If the dimension 20 is numerical (i.e. the potential values are numerical in nature), then the visualization tool 12 is configured to determine the minimum and maximum potential dimension values 24 for the dimension 20. If the dimension 20 is categorical, then the visualization tool is configured to determine all the unique values 24. The mapping tool 22 then selects a suitable shape attribute 16 for mapping to the dimension 20. The mapping tool 22 may select the suitable shape attribute 16 by a shape attribute ranking that defines the mapping criteria. That is, in one embodiment, the pre-defined mapping criteria may include for example shape attribute ranking for categorical values with a certain number of unique values (e.g. the pre-defined criteria may specify that a dimension having binary potential dimension values maps well onto a binary shape attribute having a visual characteristic such as open/closed. In another embodiment, the predefined criteria may include shape attribute rankings for a shape with 3-5 unique values, etc. Accordingly, based on the mapping between a dimension 20 and a shape attribute 16 having a particular visual characteristic 26, the mapping tool 22 is then configured to generate a visual marker for each dimension value 24 of the associated dimension by varying the visual characteristic. According to the present case, the visual characteristic 26 is modified based on the type dimension data value. That is, if the dimension data values 24 for a dimension 20 is of a numerical type then the selected visual characteristic 26 of the shape attribute 16 is modified to obtain a number of visual markers between the min data value 24 and the max data value 24. Alternatively, if the dimension data values 24 are of a categorical type, the shape attribute 16 is modified by varying the selected visual characteristic 26 to obtain visual markers 28 having unique configurations per each categoric value.

In terms of generating a visual representation of the input data 14 on the display 18, upon receiving the dimensions 20 and the associated values 24 for each dimension, the visualization tool 12 is configured to graphically represent the linked visual marker 28 associated with each dimension value 24 and dimension 20 as defined in the mapping table 34 (and visually represented as the legend 23) in replacement of the input data 14. That is, for multi-dimensional data 14, the visualization tool 12 is configured to replace each dimension 20 of the data (and corresponding dimension values 24) with the associated markers 28. The visual markers 28 from all the dimensions 20 of the data 14 are then concatenated or joined together by the visualization tool 12 to form a singular visual object 30 or glyph that is representative of the multi-dimensional data 14 and its values 24. In one aspect, concatenating the visual markers from each of the dimensions of data and associated values comprises presenting each visual marker corresponding to a different data dimension in a different visual dimension (i.e. forming a singular visual object 30 being two-dimensional or three-dimensional). The singular visual object 30 is then presented on a visual representation or display 18 of a visual interface 202.

In this manner the visualization data processing system 100 is configured to use one or more attributes of shape 16 (such as but not limited to curvature, terminators, closure, angle, intersection, holes) which can be used separately or together to convey multiple data attributes or dimensions 20 within a singular visual object 30 displayed on the display 18. In one embodiment, by varying different visual characteristics 26 (i.e. bulge, and amplitude) a plurality of visual markers 28 are obtained that can be used to represent multiple dimensions of the data 20 and their values 24. As described earlier, the plurality of visual markers 28 generated by the mapping tool 22 for representing the plurality of dimensions of data 20 (and their values 24) are joined together by the visualization tool 12 to form a singular object 30.

### Data Processing System 100

Referring to FIG. 1B, the data processing system 100 of a device 101 includes user interface device(s) 108 for interacting with the tool 12, the user interface device(s) 108 being connected to a memory 102 via a BUS 106. The device 101 comprises a computing device and may include for example a laptop or desktop computer, a mobile phone, a Personal Digital Assistant (PDA), and other types of computing devices as will be envisaged by a person skilled in the art. The interface device(s) 108 are coupled to a processor 104 via the BUS 106, to interact with user events 109 to monitor or otherwise instruct the operation of the tool 12 via an operating system 110. The user interface device(s) 108 can include one or more user input devices such as but not limited to a QWERTY keyboard, a keypad, a trackwheel, a stylus, a mouse, and a microphone. The visual interface 202 is considered to be a user output device, such as but not limited to a computer screen display, a mobile device display (such as a cell phone screen), and a PDA display. If the screen is touch sensitive, then the display can also be used as a user input device as controlled by the processor 104. Further, it is recognized that the data processing system 100 can include a computer readable storage medium 46 coupled to the processor 104 for providing instructions to the processor 104 and/or the tools 12, and 22. The computer readable medium 46 can include hardware and/or software such as, by way of example only, magnetic disks, magnetic tape, optically readable medium such as CD/DVD ROMS, and memory cards. In each case, the computer readable medium 46 may take the form of a small disk, floppy diskette, cassette, hard disk drive, solid-state memory card, or RAM provided in the memory 102. It should be noted that the above listed example computer readable mediums 46 can be used either alone or in combination. System 100 further comprises a network interface 47 to allow the system 100 to communicate with one or more public or private networks searches a LAN and/or the Internet.

Referring again to FIG. 1B, the mapping tool 22 interacts via link 116 with a visualization tool 12 (also known as a visualization renderer) of the system 100 for presenting the visual representation 18 on the visual interface 202. The mapping tool 22 processes shape attributes 16, visual characteristics 26, dimensions of data 20 and values of each dimension 24 from data files or tables 122 of the memory 102 to generate a set of visual markers 28 that can be used to represent each dimension of the data 20. As described above, the mapping between a particular dimension 20 of the multi-dimensional data 14 and a particular shape attribute 16 may be user-defined or provided by the tool 22 in response to the pre-defined mapping criteria (or a combination thereof). As discussed earlier, a selected dimension (i.e. a first dimension 20) includes a plurality of values 24 defining the dimension 20. The linking between a selected dimension value 24 (i.e. a first value) of the first dimension 20 and a visual marker 28 may also be provided by the tool 22 in response to pre-defined linking criteria, or selected by the tool 22 in combination with user input to the mapping tool 22. As discussed earlier, in one embodiment, the linking criteria is configured for use in selecting the visual marker 28 for representing the first dimension value 24. In one embodiment, the linking criteria includes a priority or ranking order assigned to selected visual characteristics 26. Additionally, the pre-defined linking criteria may rank or categorize certain visual characteristics 26 of one or more shape attributes 16 as being quantitative and thus better suited for defining quantitative dimension values 24. In another example, the pre-defined linking criteria may rank or categorize other visual characteristics 26 as being categorical (i.e. closed/open) and thus better suited to defining dimension values 24 that are also categorical in nature.

The mapping tool 22 then processes the information received from the tables 122 for subsequent presentation on the visual representation 18 via the visualization tool 12. It is recognized that the shape attributes 16, visual characteristics 26, dimensions 20 and values 24 could be stored in the same or separate tables 122, as desired. The tools 12, and/or 22 can receive requests for storing, retrieving, amending, or creating the shape attributes 16, visual characteristics 26 and linking information between the shape attributes 16 and the dimensions 20. Accordingly, the tools 12 and 14 coordinate the processing of data 14, shape attributes 16, visual characteristics 26 and visual markers 28 with respect to the content of the screen representation 18 displayed in the visual interface 202.

As will be understood by a person skilled in the art, the visualization tool 12, the mapping tool 22 and the visual interface 202 may exist on separate devices (not shown) such that the process of creating visual objects 30 associated with one or more shape attributes 16 (and one or more visual characteristics 26) to depict each dimension 20 of the data occurs on a first device and the second device is used to render the visual object 30 on the display.

The task related instructions can comprise code and/or machine readable instructions for implementing predetermined functions/operations including those of an operating system, tools 12, 22, or other information processing system, for example, in response to command or input provided by a user of the system 100. The processor 104 (also referred to as module(s) for specific components of the tool 12) as used herein is a configured device and/or set of machine-readable instructions for performing operations as described by example above.

As used herein, the processor/modules in general may comprise any one or combination of, hardware, firmware, and/or software. The processor/modules acts upon information by manipulating, analyzing, modifying, converting or transmitting information for use by an executable procedure or an information device, and/or by routing the information with respect to an output device. The processor/modules may use or comprise the capabilities of a controller or microprocessor, for example. Accordingly, any of the functionality provided by the systems and process of the accompanying figures may be implemented in hardware, software or a combination of both. Accordingly, the use of a processor/modules as a device and/or as a set of machine readable instructions is hereafter referred to generically as a processor/module for sake of simplicity.

It will be understood by a person skilled in the art that the memory 102 storage described herein is the place where data is held in an electromagnetic or optical form for access by a computer processor. In one embodiment, storage means the devices and data connected to the computer through input/output operations such as hard disk and tape systems and other forms of storage not including computer memory and other in-computer storage. In a second embodiment, in a more formal usage, storage is divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be much faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

A database is a further embodiment of memory 102 as a collection of information that is organized so that it can easily be accessed, managed, and updated. In one view, databases can be classified according to types of content: bibliographic, full-text, numeric, and images. In computing, databases are sometimes classified according to their organizational approach. As well, a relational database is a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Computer databases typically contain aggregations of data records or files, such as sales transactions, product catalogs and inventories, and customer profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory is a further embodiment of memory 102 storage as the electronic holding place for instructions and data that the computer's microprocessor can reach quickly. When the computer is in normal operation, its memory usually contains the main parts of the operating system and some or all of the application programs and related data that are being used. Memory is often used as a shorter synonym for random access memory (RAM). This kind of memory is located on one or more microchips that are physically close to the microprocessor in the computer.

### Shape Attributes 16

Referring to FIG. 2, shown are example shape attributes 16 and their exemplary visual characteristics 26 for representing the multi-dimensional data 14. As described earlier, in one case, each dimension 20 of the data may be represented visually by a visual marker 28 having different shape attribute 16 (i.e. curvature) according to a particular visual characteristic 26 (i.e. degree of curvature). In another case, different dimensions 20 of the data may be presented by the same attribute 16 (i.e. curvature) and using different visual characteristics 26 (i.e. amplitude, skew) to create perceptually different visual markers 28. As mentioned earlier, in order to represent the values 24 of a first dimension 20, a visual characteristic 26 (i.e. degree of skew) of the shape attribute 16 (i.e. curvature) is varied from a baseline amount (i.e. zero skew) to obtain the visual markers 28. That is, a first visual marker 28 may have zero skew, a second visual marker 28 may have a pre-defined other skew, etc. The first visual marker 28 may be mapped to a first potential value 24 of the first dimension 20 and the second visual marker 28 may be mapped to a second potential value of the second dimension of the data. The first and second visual markers 28 are then joined together by the visualization tool 12 to obtain a singular object 30 that is presented when the data contains the first and second potential values 24 pertaining to the first and second dimension of data 20.

Referring again to FIG. 2, shown is an example database of shape attributes 16 for processing by the mapping tool 22. FIG. 2 illustrates that each shape attribute 16 (i.e. end type) may have a number of visual characteristics 26 (i.e. width or depth of end type). In one embodiment, the visual characteristics 26 may be categorical 26a as they can be used to define dimension 20 values 24 having a number of discrete values. In another embodiment, the visual characteristic 26 may be quantitative 26b as they can be used to define dimension 20 that are quantitative in nature and more easily represented by a visual characteristic 26 having a certain range of potential deviation. In this embodiment, the visual characteristic 26 (i.e. degree of closure of a pre-defined shape) may be modified from a baseline value (i.e. iteratively varied by different amounts) to obtain the visual markers 28 having different degrees of closure and thus used to represent different values 24 of a certain dimension 20 by the visualization tool 12.

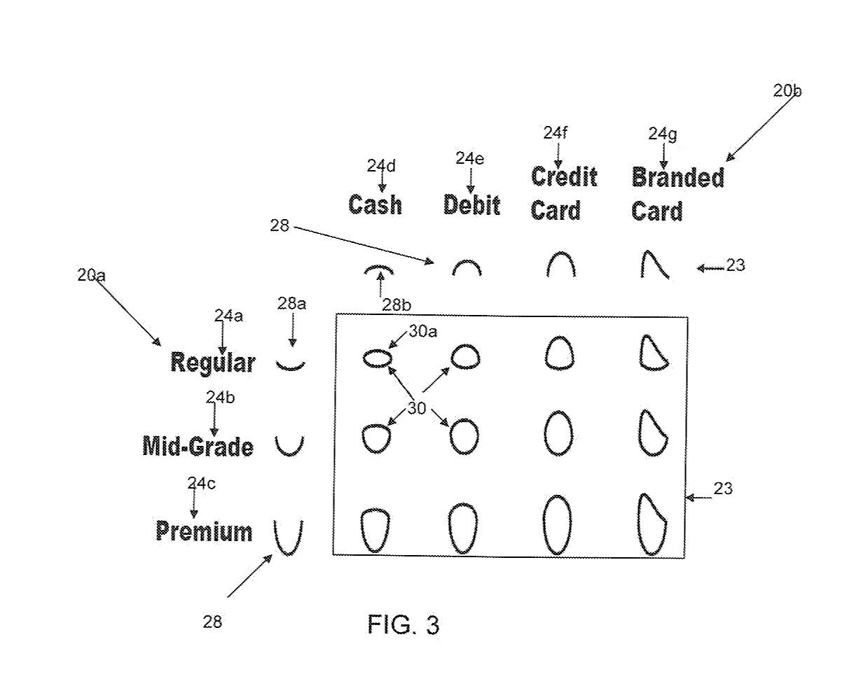

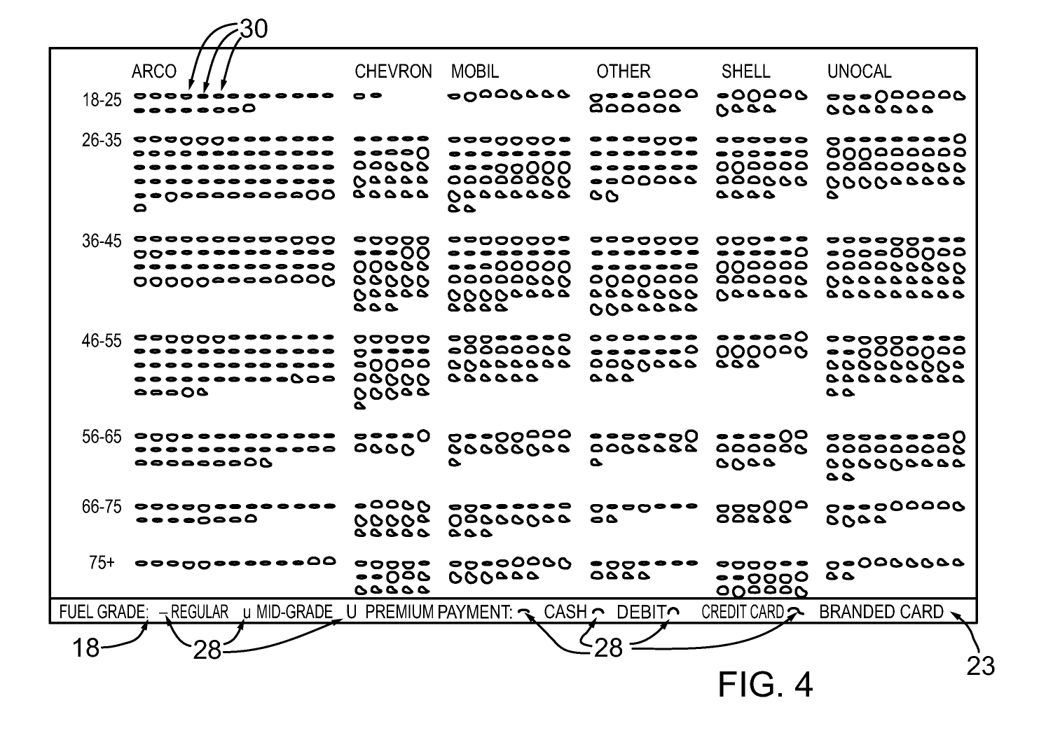

Referring now to FIGS. 3 and 4 shown is an example of using curvature as a shape attribute for representing different dimensions (20a, and 20b) of data. In the present example, the input data is a gas station survey which provides information regarding which gas station, age, fuel grade purchased, payment method, gender, etc. The first dimension 20a refers to the type of fuel grade purchased. Based on the input data 14, the first dimension 20a can have 3 potential values 24 defining the first dimension 20a. For the first dimension 20a, a first potential value 24a is regular grade, a second potential value 24b is mid-grade, and a third potential value 24c value is premium. The second dimension 20b refers to the payment method for the fuel. Based on the input data 14, the second dimension 20b can take on four different categories or values of data 24. For the second dimension 20b, the first value 24d refers to cash payment, the second value 24e refers to debit payment, the third value 24f refers to credit card payment, and the fourth value 24g refers to branded card payment. In the present example, for the first dimension and second dimensions 20a and 20b the shape attribute 16 used is curvature and only the visual characteristic 26 differs. That is, for the first dimension 20a, the visual characteristic 26 refers to amount of curvature that is being varied from a baseline shape or measure (i.e. a curve displayed in a lower quadrant) while for the second dimension 20b, the visual characteristic 26 refers to degree of skew that is being varied from a corresponding baseline shape (i.e. a curve displayed in an upper quadrant). As illustrated in FIGS. 3 and 4, the visualization tool 22 concatenates or joins together a first visual marker (i.e. 28a) corresponding to a first value (i.e. 24a) of a first dimension 20a with a second visual marker (i.e. 28b) of a second dimension 20b to form singular visual object 30a that is presented by the visualization tool 12 when the data 14 has values that correspond to a first dimension 20a having a first value 24a and a second dimension 20b having a second value 24b. As will be understood, dimension values 24a-24g are also referred to generally as dimension values or values 24; dimensions 20a, 20b as dimension 20; and visual markers 28a, 28b as markers 28 and object 30a as visual marker 30.

As described earlier, once it is defined that a particular shape attribute 16 (i.e. curvature) will be used to represent a selected dimension of the data 20 (i.e. fuel grade), then the mapping tool 22 is configured to vary a pre-defined visual characteristic 26 (i.e. degree of curvature) of the shape attribute 16 in order to generate a number of visual markers 28 that are configured for subsequent use in representing the potential values 24 of the data (i.e. mid grade, premium grade, regular grade). The linking of a selected visual marker 28 (i.e. 28a) to a selected value 24a of a dimension (i.e. 20a) may be performed in response to pre-defined criteria. The pre-defined criteria may for example, define that certain shape attributes 16 and/or certain visual characteristics 26 that are used to generate the visual marker 28 are better suited for representing a particular type of dimension 24. As described earlier, it can be envisaged certain types of dimensions 24 can have binary values or values 24 while other types of dimensions 20 can have a plurality of values 24 and thus are preferably characterized by visual markers 28 that can vary in a certain range to allow the desired linking It is noted that the potential values 24 of the data 14 refer to all the values that the data 14 can take on for a selected dimension 20 as for example, used in the legend 23. The mapping tool 22 thus creates a mapping table 34 providing the links between each visual marker 28 and its corresponding potential value 24 of a dimension 20. As illustrated in reference to FIGS. 3 and 4, each multi-dimensional data 14 is represented as a singular visual object 30 (i.e. 30a). As illustrated in FIG. 3, each multi-dimensional data 14 represents at least two dimensions of data 20 and their corresponding values (i.e. one multi-dimensional data may include a customer paying cash and buying regular gas and is represented by element 30a. Thus, the visualization tool 12 receives the mapping table information 34 which provides the linking between the values 24 of a dimension 20 and their visual markers 28. Based on the mapping table 34, the visualization tool 12 is configured to analyze the input data 14 (i.e. the gas survey data), replace the data values corresponding to each value 24 of each dimension 20 (i.e. element 24a of dimension 20a and element 24a of element 28b) with its corresponding visual marker (i.e. visual markers 28a and 28b) and concatenate the visual markers 28 to form a singular visual object 30a.

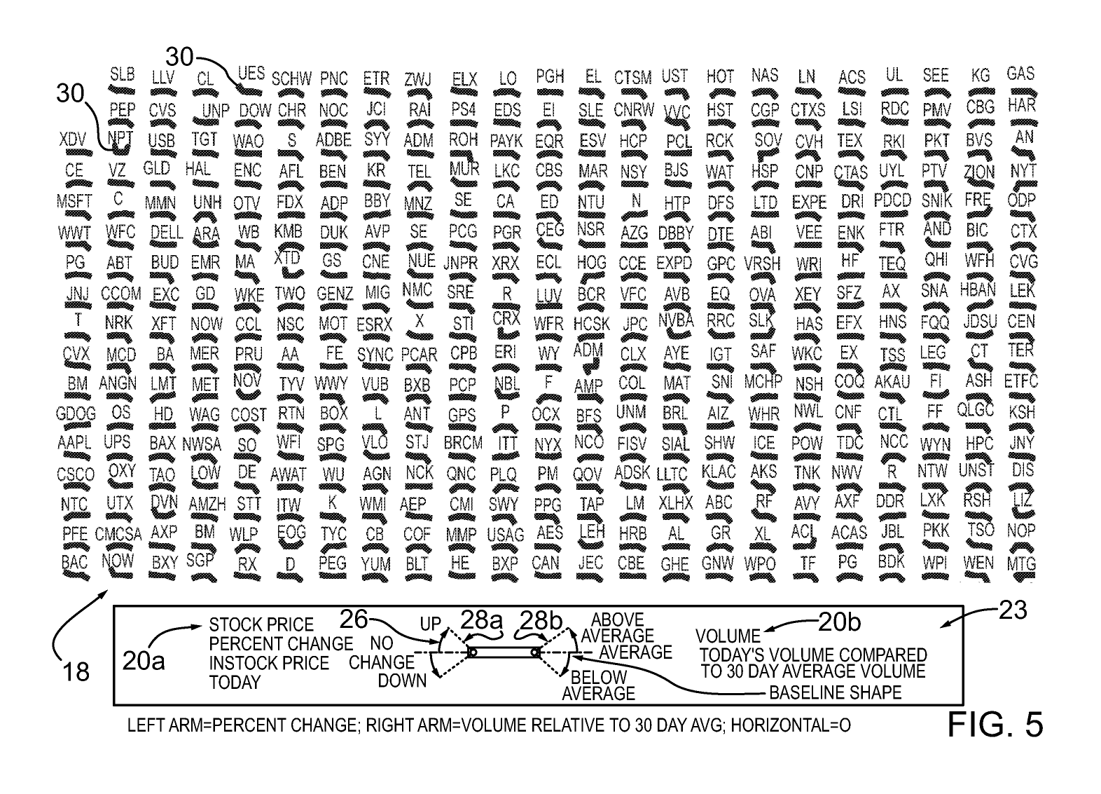

Referring to FIG. 5 shown is an example embodiment of presenting a visual representation 18 via by depicting different dimensions 20 of the data 14 using the same type of shape attribute 16 in order to define the visual objects 30 that represent the underlying two dimensional data 14. In the illustrated embodiment a separator or a connector is used to visually distinguish a first visual marker 28a for representing a first dimension of data 20a (i.e. stock price) and a second visual marker 28b for representing a second dimension of data 28b (i.e. volume). In the illustrated example, the visual characteristic 26 is the angle of the line for the visual marker 28 and the degree of the angle relative to the horizontal baseline shape provides the plurality of visual markers 28 to represent the potential value 24 values for the dimension 20. Accordingly, each stock having two dimensional values (corresponding to the stock price and the volume) is depicted by the visual object 30 which is illustrated as the connection (via a separating element) of the first visual marker 28a and the second visual marker 28b relating to the two dimensions 20 of the data.

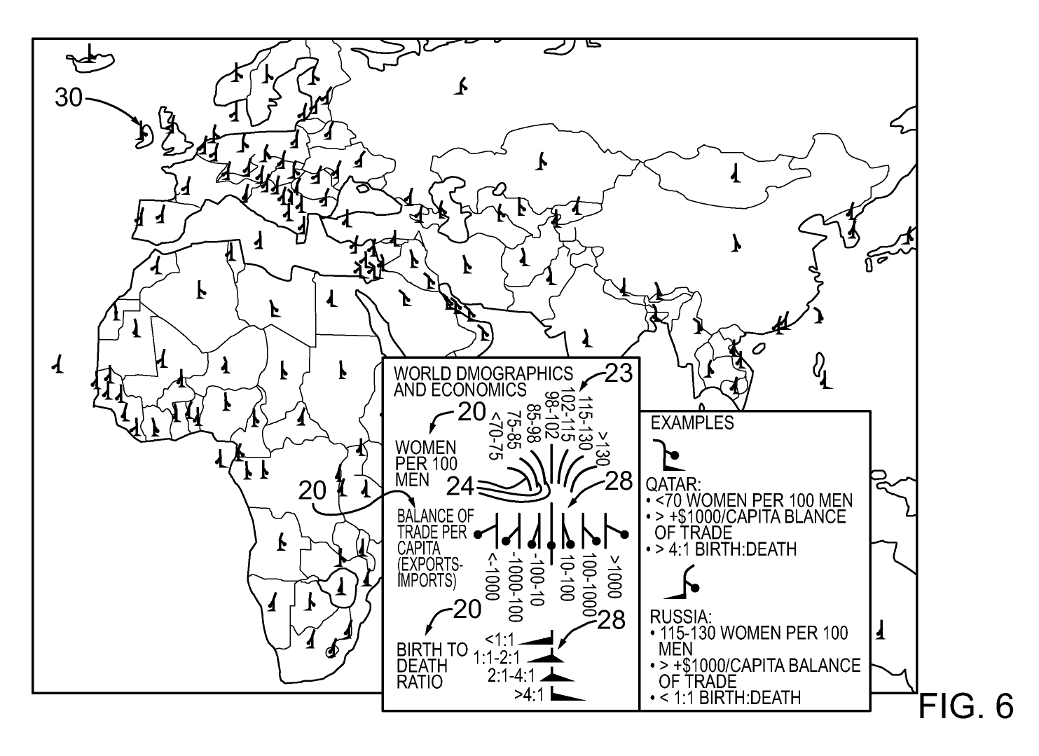

Referring to FIG. 6, shown is an example embodiment of depicting three different dimensions or data attributes 20 using three different sets of visual markers 28 (generated from different shape attributes 16). As discussed earlier a linking is defined between a particular visual marker 28 and a corresponding value 24 (i.e. value <70) of a mapped dimension (i.e. dimension “Women per 100 men” mapped to a curvature-based shape attribute 16). As discussed earlier, the linking may be based on pre-defined criteria which may define that, for example a curve having a smaller degree of curvature (as defined by the visual characteristic 26) is to be associated with the value of the plurality of values 24 that is the smallest quantity (i.e. value <70).

That is, in one embodiment, the pre-defined criteria that defines the link between the linked visual marker 28 and a selected dimension value 24 of the data 14 may be in dependence upon a correlation between the pre-defined measure of variance and a relative size of the selected dimension value 24 to the other values within a same dimension 20.

Referring again to FIG. 6, each of the three potential dimensions of the data 20 and their associated values 24 are visually differentiated by being visually represented by four different shape attributes 16 (i.e. curvature, angle, and terminator). The values of the data 24 are then differentiated by generating different visual markers 28. That is, the different visual markers 28 for each dimension of data 20 are generated by varying a pre-defined visual characteristic 26 of each of the shape attributes 16 by a pre-defined measure. For each set of multi-dimensional data 14, the visual markers 28 are joined together to form the singular visual object 30 depicting the multiple dimensions 20 and their values 24. A legend 23 representing the mapping table 34 information is displayed on the display 18 and can then be used by a user of the computing device for decomposing the visual object 30 into its underlying dimensions 20.

Accordingly, in one embodiment depicted in FIG. 6, different dimensions 20 of the data are mapped to different shape attributes 16 in order to maximize distinctness of the overall visual object 30.

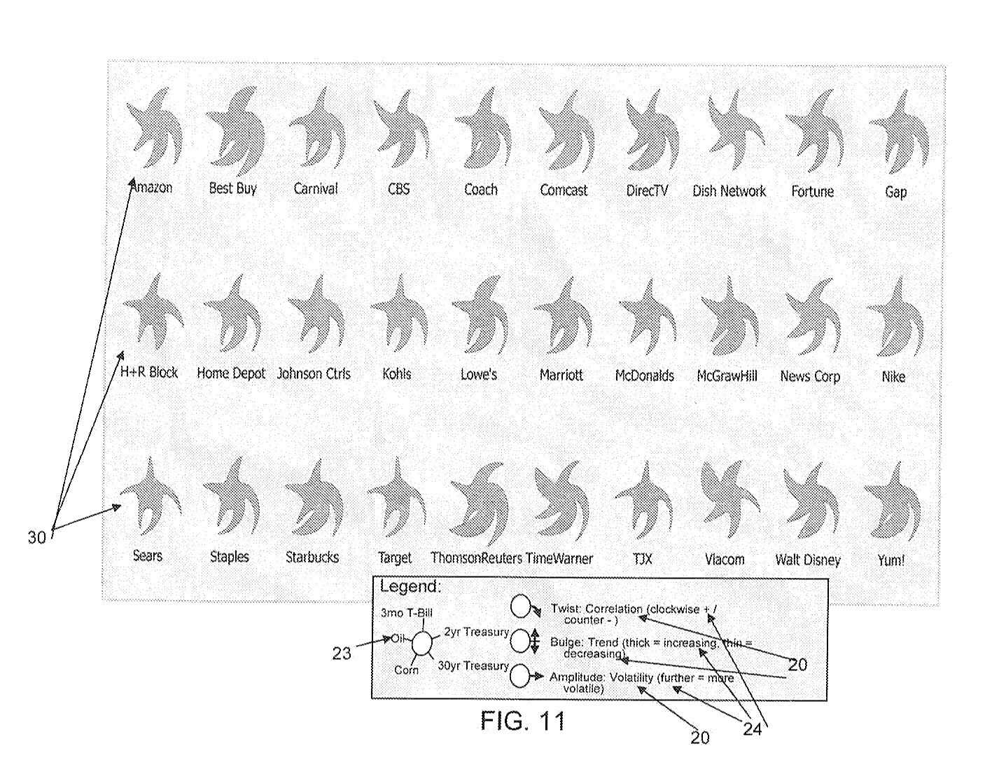

Referring to FIG. 11, shown is an example of visually depicting stock correlations to commodities using twist, bulge and amplitude to indicate three variables or dimensions 20 of the data. In the embodiment illustrated in FIG. 11, the same shape attribute 16 is utilized for depicting multiple dimensions 20 of data. In this case, 5 pairs of variables or 5 sets of multi-dimensional data are depicted as the arms of a star. Further the dimensions 20 of correlation, trend and volatility are each represented by different visual characteristics 26 of twist, bulge and amplitude. The degree or amount of twist, bulge and amplitude representing the value 24 for each dimension 20.

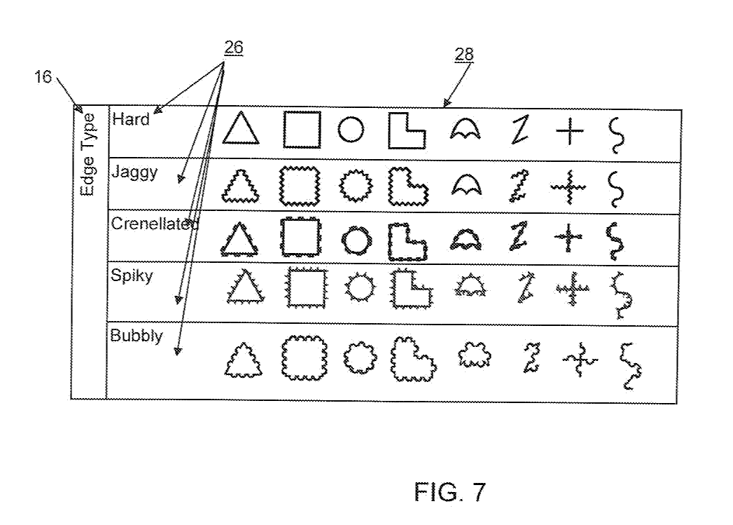

Referring to FIG. 7, there is illustrated a chart depicting an exemplary selected shape attribute 16 (i.e. edge type) and potential visual characteristics 26 (i.e. hard, jaggy, crenellated, spiky, bubbly) associated with particular shapes that may be used to generate a plurality of visual markers 28.

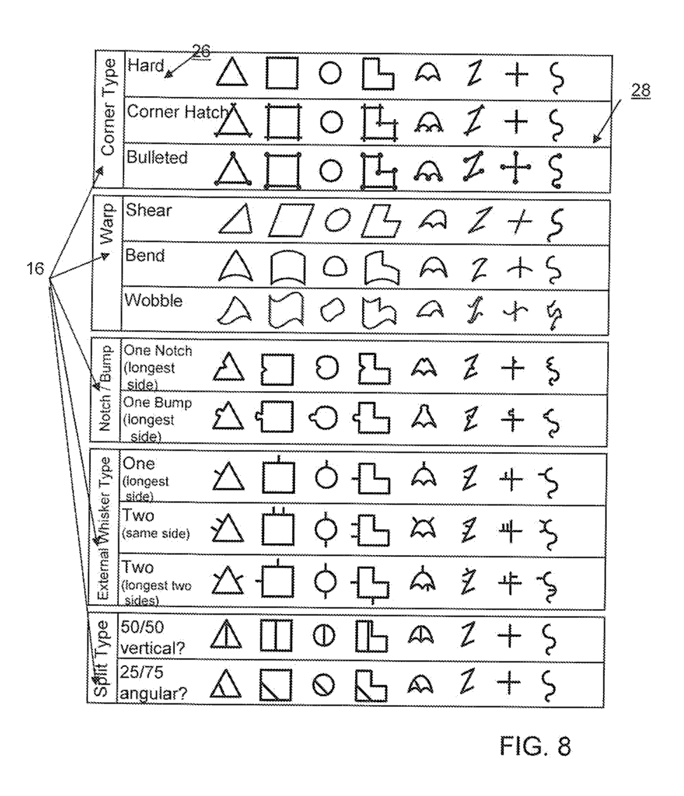

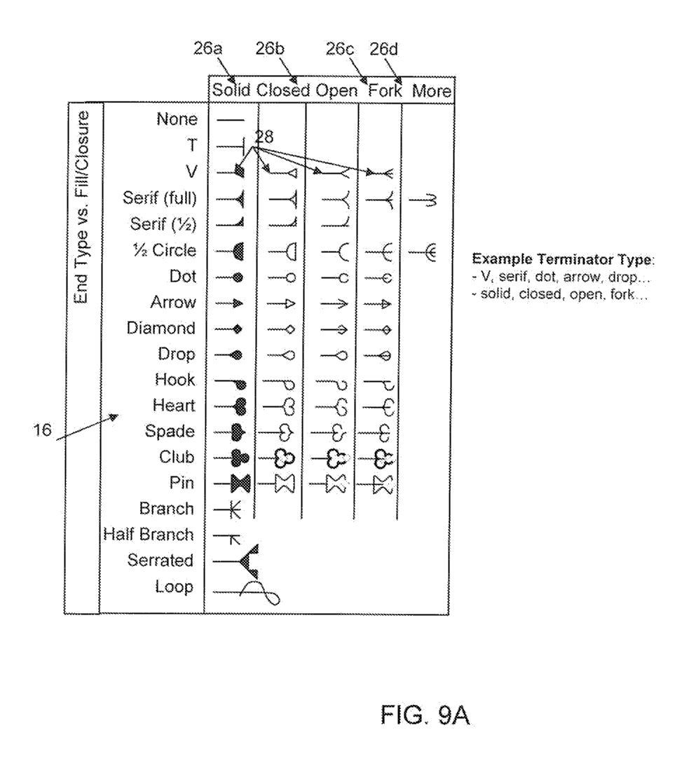

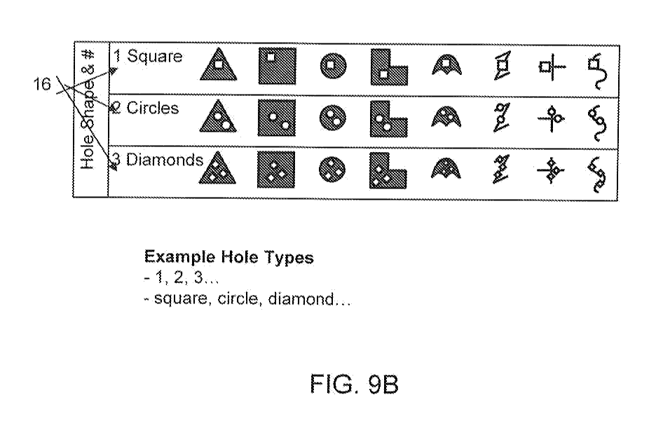

FIG. 8 illustrates a chart depicting exemplary shape attributes 16 (corner type, warp, notch/bump, whisker type, split type) and associated exemplary visual characteristics 26. For example, for corner type attribute 16, the characteristics 26 may include hard, rounded, bevelled, corner hatch, bulleted, and serifed. For warp type attribute 16, the characteristics 26 may include shear, bend, wobble, and twist. For external whiskers type attribute 16, the characteristics 26 may include no whiskers, 1 (i.e. on the longest side), 2 (on the same side), 2 (on the longest 2 sides), 1 (off of corner) as well as internal whiskers and crossing whiskers. For the notch/bump type attribute 16 the characteristics can include none, or a number of notch/bumps. For internal splits attribute 16, the characteristics can include none, 1 (vertical split into equal area), 1 (angular split 75/25), 2 splits . . . Referring to FIG. 9A there is illustrated an additional potential shape attribute 16 (i.e. end type) and visual characteristics 26a-26d that define the type of terminator. Referring to FIG. 9B, there is illustrated the exemplary shape attribute 16 of holes and defining characteristics 26 including shape of holes and number.

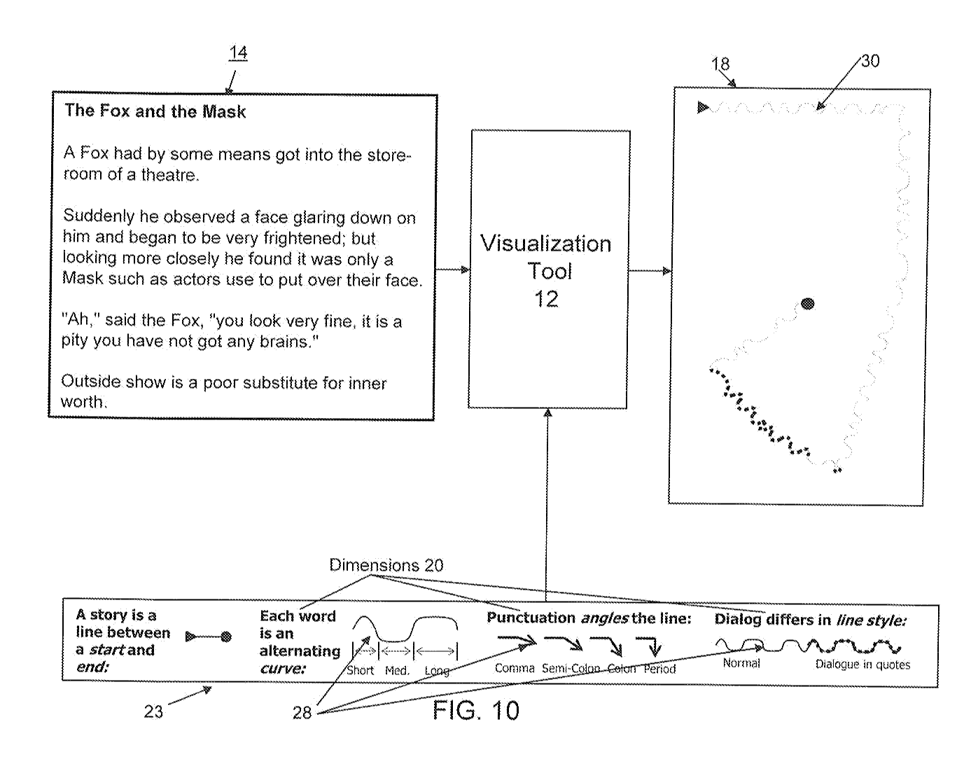

Referring now to FIG. 10, there is shown an example where the data 14 includes a story having specific sentence structure and dialogue. The story is decomposed into its dimensions 20 and values 24. The mapping table 34 defining the linking between the visual markers 28 and the values 24 of a dimension of data 20 is provided (i.e. via the mapping tool 22) to the visualization tool 12. Accordingly, the data 14 is represented on the display 18 as a series of visual markers 28 connected to each other to form a singular visual object 30 depicting the multi-dimensional data 14.

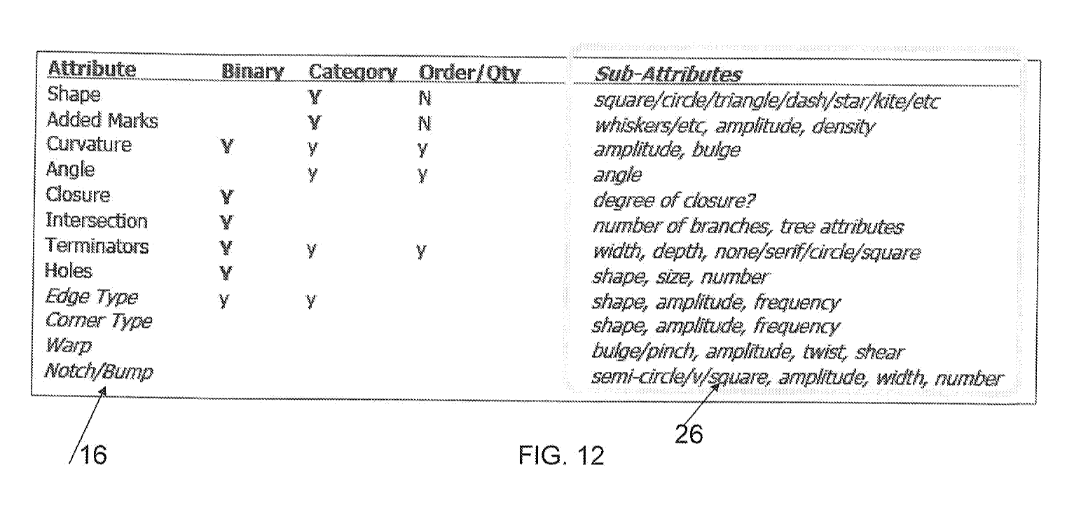

Referring to FIG. 12 shown are example shape attribute 16 and their subattributes for defining visual characteristics 26 of the shape that can be modified to generate the plurality of visual markers 28.

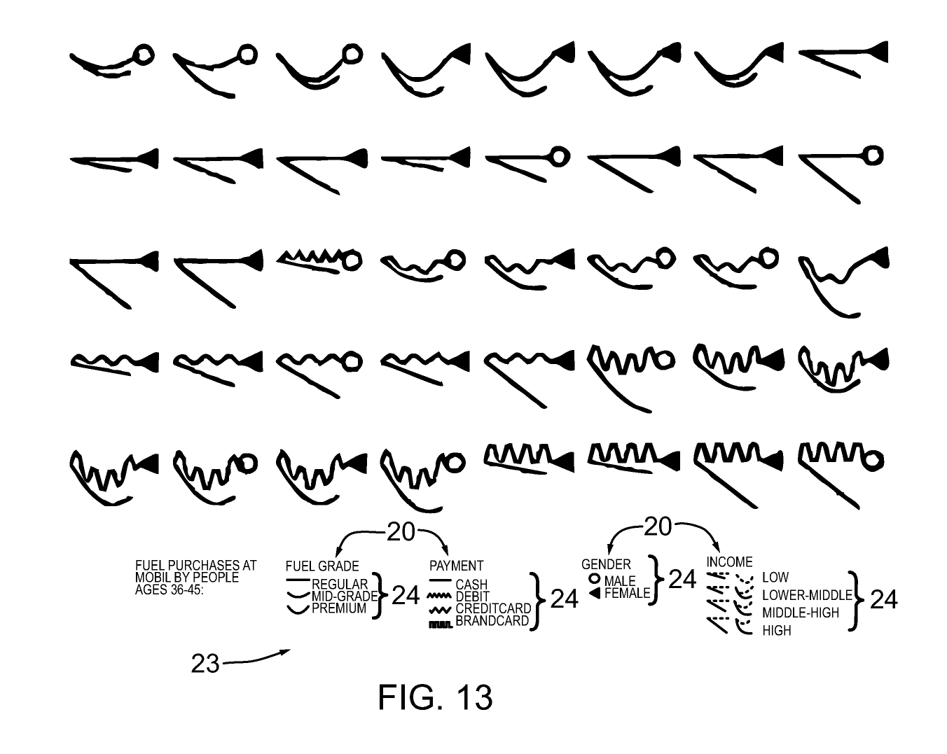

Referring to FIG. 13 shown is an example for generating singular visual objects 30 (provided by the visualization tool 12 and the mapping tool 22) for each subset of multi-dimensional data 14 using different shape attributes (i.e. using curvature, edge type, terminator, and angle) to represent different dimensions of the data (fuel grade, payment, gender, and income). That is, a first dimension of data 20 (fuel grade) is represented by a first type of shape attribute 16 (i.e. curvature). Within each dimension 20 of the data, each dimension value 24 is represented by a visual marker 28 generated by modifying a pre-defined visual characteristic 26 of the corresponding shape attribute 16.

Although preferred embodiments of the invention have been described herein, it will be understood by those skilled in the art that variations may be made thereto without departing from the spirit of the invention or the scope of the appended claims.

What is claimed is:

1. A computer-implemented method, executed by a processor, for visualizing multi-dimensional data on a user interface of a computing device, each dimension of the data having a plurality of dimension values, the method comprising:
receiving mapping information defining at least one mapping between each potential dimension of the data to a corresponding shape attribute;
generating, for each dimension of the data, a plurality of visual markers in response to varying a pre-defined visual characteristic of the corresponding shape attribute from a baseline shape for the characteristic, the plurality of visual markers configured for representing the dimension values of the dimension and each of the visual markers varying a pre-defined measure from the baseline shape;
defining, for each dimension of the data, a link between each visual marker associated with the corresponding shape attribute with each potential dimension value of the plurality of dimension values, the link defined in response to pre-defined criteria; and
representing each dimension value of each dimension of the multi-dimensional data with the linked visual marker and concatenating the plurality of visual markers corresponding to each of the different dimensions of the multi-dimensional data and associated dimension values to form a singular visual object for visualizing the multi-dimensional data and associated dimension values.

2. The method of claim 1, further comprising: receiving input on the user interface from a user of the device for allowing one or more of defining the mapping information; modifying the mapping information; selecting the visual characteristic; and selecting the pre-defined criteria for determining the link between each visual marker and a selected dimension value of the data.

3. The method of claim 1, wherein concatenating the visual markers from each of the dimensions of data and associated values comprises presenting each visual marker corresponding to a different data dimension in a different visual dimension.

4. The method of claim 3, wherein the visual object is displayed as one of a two-dimensional or a three-dimensional object.

5. The method of claim 1, wherein the shape attributes are selected from the group comprising: closure, curvature, corner angle, edge type, corner type, end type, notch, bump, whiskers, holes, intersection, and local warp.

6. The method of claim 5, wherein the visual characteristics of the shape attributes are selected from the group comprising: degree of closure, amplitude, skew, bulge, degree of angle, amplitude, frequency, size, width, depth, density, length, number, number of spokes of an intersection, and factor.

7. The method of claim 5, wherein the visual characteristics of the shape attributes are selected from the group comprising: closed closure, open closure, degrees of curvature, straight edge, spiky edge, sharp corner, round corner, serif corner, serif end type, dot end type, v-shaped notch, half-round notch, sloping whiskers, amount of whiskers, shape of holes, number of holes, shear of warp, twist of warp, bulge of warp, and shape of notch.

8. The method of claim 1, wherein each visual marker of the visual markers connected together to form the visual object represents different dimensions of the multi-dimensional data and is visually displayed in different quadrants of the user interface.

9. The method of claim 1, wherein the mapping information is configured to define that each dimension of the multi-dimensional data is mapped to different shape attributes of a plurality of shape attributes such that the singular visual object depicting the multi-dimensional data comprises visual markers associated with the plurality of shape attributes.

10. The method of claim 1, wherein the corresponding shape attribute is selected in dependence upon a type of the potential dimension values for the dimension such that the corresponding shape attribute is associated for defining either categorical data having discrete potential dimension values or quantitative data having a range of potential dimension values.

11. The method of claim 1, wherein the visual markers corresponding to different dimensions of the multi-dimensional data are generated from the same corresponding shape attribute having different visual characteristics.

12. The method of claim 1, wherein the pre-defined criteria for linking each visual marker with each potential dimension value associated with the selected dimension is dependent upon the number of potential dimension values for the selected dimension.

13. The method of claim 1, wherein the pre-defined criteria defines that the link between the linked visual marker and a selected dimension value of the data is in dependence upon a correlation between the pre-defined measure of variance and a relative size of the selected dimension value to the other values within a same dimension.

14. A computer-implemented system for visualizing multi-dimensional data on a visual interface of a computing device, each dimension of the multi-dimensional data having a plurality of dimension values, the system comprising:
a mapping tool for generating mapping information defining at least one mapping between each potential dimension of the data to a corresponding shape attribute, the mapping information generated in response to pre-defined criteria, the mapping tool further configured for generating, for each dimension of the data, a plurality of visual markers in response to varying a pre-defined visual characteristic of the corresponding shape attribute from a baseline shape for the characteristic, the plurality of visual markers configured for representing the dimension values of the dimension and each of the visual markers varying a pre-defined measure from the baseline shape, the mapping tool further configured for defining a mapping table for providing, for each dimension of the data, a link between each visual markers associated with the corresponding shape attribute with each potential dimension value of the plurality of dimension values, the link defined in response to pre-defined criteria; and
a visualization tool for representing each dimension value of each dimension of the multi-dimensional data with the linked visual marker and concatenating the plurality of visual markers corresponding to each of the different dimensions of the multi-dimensional data and associated dimension values to form a singular visual object for visualizing the multi-dimensional data and associated dimension values in response to receiving the mapping table at the visualization tool.

15. The system of claim 14, further comprising: providing a user interface for receiving input from a user of the device for allowing one or more of defining the mapping information; modifying the mapping information; selecting the visual characteristic; and selecting the pre-defined criteria for determining the link between each visual marker and a selected dimension value of the data.

16. The system of claim 14, wherein the mapping information is configured to define that each dimension of the multi-dimensional data is mapped to different shape attributes of a plurality of shape attributes such that the singular visual object depicting the multi-dimensional data comprises visual markers associated with the plurality of shape attributes.

17. The system of claim 14, wherein the corresponding shape attribute is selected in dependence upon a type of the potential dimension values for the dimension such that the corresponding shape attribute is associated for defining either categorical data having discrete potential dimension values or quantitative data having a range of potential dimension values.

18. The system of claim 14, wherein the visual markers corresponding to different dimensions of the multi-dimensional data are generated from the same corresponding shape attribute having different visual characteristics.

19. The system of claim 14, wherein the pre-defined criteria for linking each visual marker with each potential dimension value associated with the selected dimension is dependent upon the number of potential dimension values for the selected dimension.

20. The system of claim 14, wherein the pre-defined criteria defines that the link between the linked visual marker and a selected dimension value of the data is in dependence upon a correlation between the pre-defined measure of variance and a relative size of the selected dimension value to the other values within a same dimension.
